(19) United States
(12) Patent Application Publication
(10) Pub. No.: US 2026/0034591 A1
(43) Pub. Date: Feb. 5, 2026

(54) MACHINE TOOL SYSTEM AND METHOD FOR OPERATING A MACHINE TOOL SYSTEM

(71) Applicant: Siemens Aktiengesellschaft, München (DE)

(72) Inventors: Ralf Spielmann, Stuttgart (DE); Loay Alkafafi, Erlangen (DE); Philip Joachim Rack, Stuttgart (DE)

(73) Assignee: Siemens Aktiengesellschaft, München (DE)

(21) Appl. No.: 19/285,745

(22) Filed: Jul. 30, 2025

(30) Foreign Application Priority Data
Jul. 31, 2024 (EP) 24192087.5

(51) Int. Cl. B23C 1/00

(52) U.S. Cl. CPC B23C 1/002

(57) ABSTRACT

A machine tool system has a machine tool with a stationary machine base, support elements connected to the machine base, and a crossbeam connected to the support elements. The crossbeam is adjustable relative to the support elements in a Z-direction or the support elements are adjustable relative to the machine base in an X-direction. A tool holder head is mounted on the crossbeam and adjustable for travel in a Y-direction along the crossbeam. The X-, Y- and Z directions form a cartesian coordinate system. A control facility is connected to the machine tool for controlling travel in the Y-direction and adjustment in at least one of the X- and/or Z-directions based on a kinematic parameter specified as a function of a position of the tool holder head relative to the Y-axis and thus takes into account asymmetric load distribution caused by movement of the tool holder head.

### CROSS-REFERENCES TO RELATED APPLICATIONS

This application claims the priority of European Patent Application, Serial No. 2192087.5, filed Jul. 31, 2024, pursuant to 35 U.S.C. 119 (a)-(d), the disclosure of which is incorporated herein by reference in its entirety as if fully set forth herein.

### BACKGROUND OF THE INVENTION

The invention relates to a to a machine tool system with a machine tool, to a method for operating a machine tool system, and to a control facility, in particular a numerical (CNC) controller, for such a machine tool system.

The following discussion of related art is provided to assist the reader in understanding the advantages of the invention, and is not to be construed as an admission that this related art is prior art to this invention.

In gantry machines, various machine elements, such as for example the columns or the crossbeam, are moved in each case by multiple machine axes operating in parallel or synchronously, hereinafter also designated merely as “axes” for short. The axes, which jointly move a machine part, are also known as gantry axes or a gantry assembly. Due to their mechanical structure, the gantry axes are joined rigidly together and accordingly always have to be traversed synchronously by the controller.

When the parallel-operating axes are in motion, load distribution between the two or more gantry axes, or in the gantry assembly, is generally not symmetrical. For example, in the case of the gantry machine shown in FIG. 1, load distribution in (machine) axes Z1 and Z2, which bear the crossbeam with the Y axis, is only identical (without mechanical effects such as friction etc.) when the Y axis or the center of gravity thereof or the tool holder head mounted adjustably to the Y axis is exactly central between the Z1 and Z2 axes. If, on the other hand, the Y axis is moved right over to one side, for example to the Z1 axis, load distribution in the gantry assembly is at its most asymmetrical.

The position of the Y axis not only affects load distribution in axes Z1 and Z2, but also the dynamic distribution or dynamic reserve of the axes Z1 and Z2 (closed-loop control is not meant here, i.e., not KV, KP, or TN). Only if the Y axis is exactly central between the Z1 and Z2 axes is the current needed by the respective drives of the Z1 and Z2 axes to move the axes Z1 and Z2 synchronously upward against gravity identical (apart from mechanical effects such as friction etc.). In particular, if the Y axis is moved right over to one side, for example to the Z1 axis, the current needed in the drives of axes Z1 and Z2 is at its most asymmetrical.

The same is true for load distribution in the gantry machine's two X axes X1 and X2. Here too, load distribution and in particular the position of the tool holder head and the inertia thereof has an effect on the drive currents needed for axes X1 and X2 in order to achieve desired acceleration or desired jerk.

The parameter settings for the dynamics of a gantry assembly are today always designed for the most asymmetric case. Hence, for example, the maximum acceleration of the gantry assembly according to FIG. 1 for the crossbeam specifiable by the control facility is set such that the maximum admissible current in the drives of the Z1 and Z2 axes is still sufficient to accelerate the crossbeam with the specified, maximum acceleration even if the Y axis and with it the tool holder head has been displaced (traversed) completely to one side.

A disadvantage of known approaches is that gantry machines are frequently not operated with the maximal possible machine axis acceleration, which unnecessarily extends the working time needed to machine a workpiece using such a gantry machine.

It would therefore be desirable and advantageous to reduce the working time needed to machine a workpiece on a machine tool, in particular a gantry machine and to obviate other prior art shortcomings.

### SUMMARY OF THE INVENTION

According to one aspect of the invention, a machine tool system with a machine tool includes a stationary machine base, two support elements connected to the machine base and oriented in parallel in a third spatial direction, a crossbeam connected to the two parallel support elements and oriented in a second spatial direction, wherein the crossbeam is adjustable relative to the two parallel support elements by a third drive along two third parallel machine axes in the third spatial direction or the two support elements are adjustable relative to the machine base by a first drive along two first parallel machine axes in a first spatial direction. A tool holder head is mounted on the crossbeam and adjustable by a second drive along a second machine axis in the second spatial direction along the crossbeam. A control facility is connected to the machine tool for controlling the second and at least one of the first drive and the third drive, wherein at least one kinematic parameter of at least one the first and the third machine axes is specified as a function of a position of the tool holder head relative to the second machine axis.

According to another aspect of the invention, a method for operating a machine tool system having a machine tool as set forth above includes adjusting the tool holder head with a second drive along a second machine axis in the second spatial direction along the crossbeam; adjusting the crossbeam relative to the support elements with a third drive along two third parallel machine axes in the third spatial direction and/or adjusting the two support elements relative to the machine base with the first drive along two first parallel machine axes in a first spatial direction; and determining at least one kinematic parameter of the first and/or the third machine axes and setting the at least one kinematic parameter as a function of a position of the tool holder head relative to the second machine axis.

Further aspects of the invention are directed to a control facility for controlling a machine tool system as set forth above and a digital twin of the aforedescribed machine tool system configured to simulate machining of a workpiece with the at least one kinematic parameter being dependent on a position of the tool holder head relative to the second machine axis.

The invention offers the advantage that whenever the tool holder head is not maximally displaced to one side of the crossbeam, a higher maximum admissible velocity and/or a higher maximum admissible acceleration and/or a higher maximum admissible jerk can be specified or set for both the parallel first and/or both the parallel third machine axes than has been the case hitherto with machine tools, in particular gantry machines, without thereby overloading the machine axis drives. The stated variable maximum values mean the machine is adaptable to asymmetrical load distribution, so reducing the working time needed for such a machine tool to machine a workpiece compared with a conventional machine tool.

With the machine tool according to the invention, a tool for machining a workpiece is adjustable in at least two, conventionally three, linear axis directions relative to the workpiece. In this case, in a machine with three (or more) linear axes at least one axis may also be implemented in that a workpiece holder, in particular a workpiece table, to which the workpiece is mounted, is adjustable in the direction of this axis relative to the machine base.

The invention is typically used in gantry machines but is not limited to this type of machine. Gantry machines are conventionally constructed and set up such that the two support elements (columns) mounted to a horizontal floor plate or machine base extend in the vertical Z direction in the Cartesian machine coordinate system and are adjustable along the horizontal X direction. A crossbeam mounted to the columns extends in the horizontal Y direction and is adjustable in the Z direction through being mounted adjustably to the columns. However, the invention also encompasses machine tools which differ from this machine axis set-up and orientation that is conventional in gantry machines.

When, in particular, the Y axis is exactly midway between the Z1 and Z2 axes, in a conventional gantry machine the axes Z1 and Z2 have in each case to bear just half of the load of the crossbeam. Thus, the maximum current admissible for the respective axis may be applied to both axes, which may thus be maximally accelerated.

According to another advantageous feature of the invention, the dependency of the kinematic parameter on the position of the tool holder head can be settable. This in particular enables rapid and simple adaptation of the kinematic parameter to different loads, in particular to the mass of the tool holder head used in each case and optionally attached parts mounted thereto such as tool holders and/or tools. Corresponding settings and adjustments may preferably be carried out directly using the machine's control facility.

The dependency of the kinematic parameter on the position of the tool holder head may, for example, take place in stages, the Y axis being subdivided into multiple zones for example. However, the dependency is preferably specified using a continuously and constantly extending characteristic curve. Specification is always carried out such that the predetermined, position-dependent maximum of the kinematic parameter may be achieved without exceeding the maximum admissible current (maximum current intensity) specified for the respective axis.

For the purposes of the invention, the critical kinematic parameter is the maximum admissible values (maximum values or maxima) for the respective axis in terms of acceleration or jerk. It may, however, also be a maximum velocity. For instance, in the case of asymmetrical load distribution a lower maximum velocity may be admissible than in the case of symmetrical load distribution, for example in order to be able to comply with a specified maximum braking distance of the machine's crossbeam.

When adapting the kinematic parameter to a load distribution which is asymmetrical relative to the vertically oriented columns, it is principally the weight force of the tool holder head that is relevant with regard to the Z axes. Inertia here has a lesser effect, at least in the range of relatively low maximum possible axis accelerations. On the other hand, in the case of the X axes, which are unaffected by the weight force of the tool holder head, it is the inertia thereof that is of relevance to the position-dependent specification or setting of maximum acceleration.

The physical relationship F=m*a applies to the accelerated movement of a mass. In the case of a specified maximum force, namely the maximum force which the drive of the axis in question can apply, the achievable acceleration is thus indirectly and proportionally dependent on the accelerated mass. In the context of the invention, the mass of the crossbeam per se, i.e., any attached parts such as the tool holder head mounted thereto, is typically of no significance, since the crossbeam is in mostly of symmetrical construction and the forces are therefore uniformly distributed over the drives. It is a different matter for the tool holder head, which may move to and for along the crossbeam or the Y axis between the two columns. For instance, in the case of minimum or maximum excursion of the Y axis, the force for accelerating the mass of the tool holder head and any attached parts mounted thereto has to be at least virtually completely applied by in each case one of the parallel drives. However, since the rigid gantry of a gantry machine means that the parallel axes can in each case only be uniformly (synchronously) traversed or accelerated, the result is the maximum possible acceleration for the crossbeam as a whole. In the case of a specified maximum force of the identically constructed parallel drives, the maximum possible acceleration of the crossbeam (including tool holder head) is at its greatest when the tool holder head is located centrally between the columns and the masses to be accelerated are uniformly distributed over the drives.

The effect of the invention is therefore all the greater, the higher is the proportion of the mass of the tool holder head relative to the total mass of the crossbeam (including tool holder head).

According to another advantageous feature of the invention, the control facility used in the context of the invention may be configured to acquire the weight and/or mass at least of the tool holder head and to set the kinematic parameter automatically as a function of the position and acquired weight and/or acquired mass of the tool holder head.

For example, the weight and/or mass of the tool holder head can be input manually into the controller. It is however also possible merely for an identifier of the tool holder head, e.g., a part number, to be input into the controller or transmitted to the controller, the controller automatically taking the weight and/or the mass from a database of relevance to the identifier.

Advantageously, to determine and set the kinematic parameter it is not only the weight and/or the mass of the tool holder head that is taken into account, but also the weight and/or the mass of at least one attached part connectable thereto, such as a tool holder, a tool extension or a tool.

According to another advantageous feature of the invention, the weight and/or mass (inertia) of the tool holder head may be determined automatically by the control facility by using test runs and stored in the control facility. In the case, in particular, of minimum or maximum excursion of the Y axis, runs at constant velocity or constant acceleration can be used to determine the weight or mass of the tool holder head and any attached parts mounted thereto by comparing the motor currents of the parallel-traversable axes on the basis of interrelationships known to a person skilled in the art. The control facility has the measuring and computing means necessary for this purpose, and suitable software.

Automatic determination and position-dependent adaptation of the maxima of velocity, acceleration, and/or jerk enables adjustment to take place with minimum additional effort on the part of the user of the machine.

The invention is of particular relevance for “conventional” gantry machines, in which the first (X) and third (Z) spatial or axis directions are horizontally oriented and the second spatial or axis direction (Y) is vertically oriented. The first (X), second (Y), and third (Z) spatial directions are in this case oriented perpendicular to one another and form a Cartesian coordinate system.

However, machine tools are also known which differ from this orientation conventional in gantry machines and in which, for example, the support elements extend in the horizontal (X) direction.

The gantry machine according to the invention can be a gantry milling machine, with which milling machining of a workpiece is possible.

It goes without saying that the machine tool according to the invention may also have more than the above-stated number of machine axes, in particular one or two rotary axes, for example at a workpiece table or the tool holder head, such that five-axis machining of the workpiece is, for example, also possible.

### BRIEF DESCRIPTION OF THE DRAWING

Other features and advantages of the invention will be more readily apparent upon reading the following description of currently preferred exemplified embodiments of the invention with reference to the accompanying drawing, in which:

FIG. 1 shows a gantry machine system with a gantry machine and a CNC controller; and

FIG. 2 shows method steps for carrying out a method according to the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the invention or which render other details difficult to perceive may have been omitted.

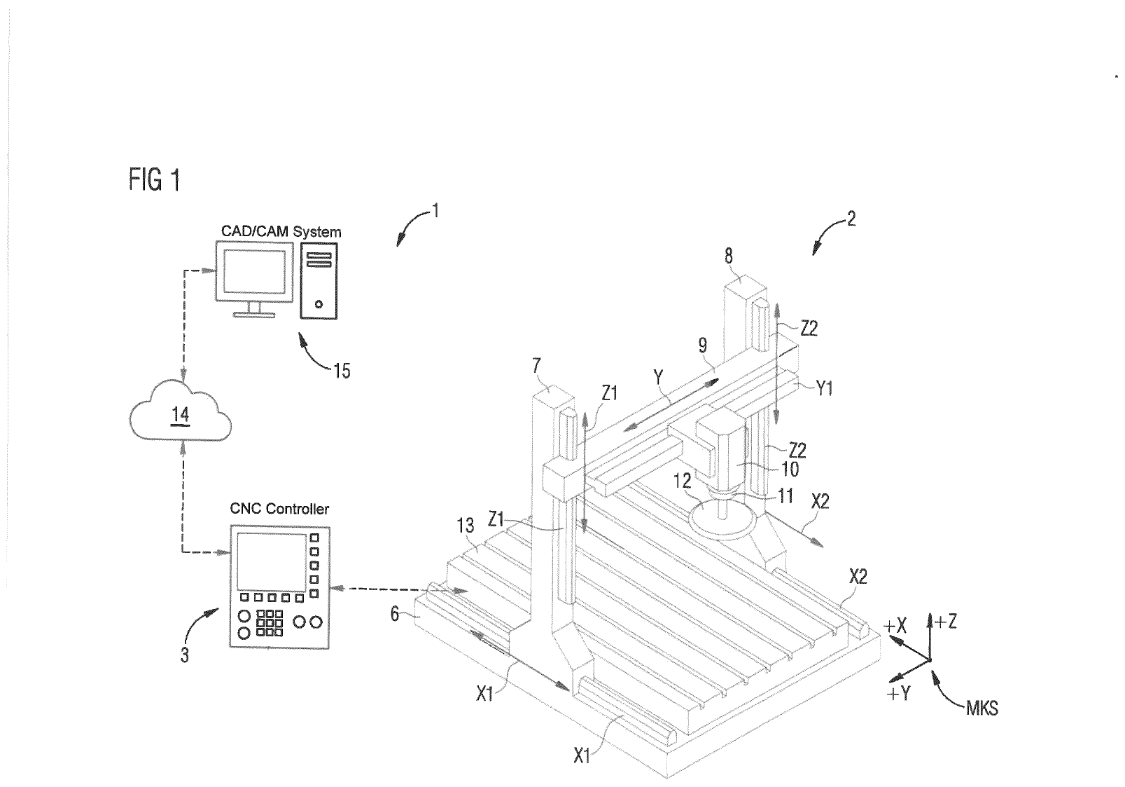

Turning now to the drawing, and in particular to FIG. 1, there is shown a machine tool system in the form of a gantry machine system 1 comprising a machine tool in the form of a gantry machine 2, for example a gantry grinding machine, and a control facility, e.g., a numerical or CNC controller 3, connected to the gantry machine 2 for controlling the gantry machine 2. The gantry machine system 1 further comprises an external computing device, in particular in the form of a CAD/CAM system 15, connected to the CNC controller 3 by way of a network 14.

The gantry machine 2 depicted comprises a horizontally oriented machine bed 6, also designated machine base (base) or floor plate, at the sides of which the two columns 7 and 8 are arranged and oriented in the vertical (Z) direction. Column 7 is connected adjustably to the machine bed 6 via an adjustable X1 axis and column 8 via an adjustable X2 axis. Adjustment (traversing movement) of the X1 and X2 axes takes place synchronously under the control of the CNC controller 3. The two columns 7 and 8 are connected together via a crossbeam 9 which, together with the two columns 7 and 8, forms a portal. The crossbeam 9 is displaceable in the Z direction by means of adjustable machine axes Z1 and Z2, wherein, similar to the axes X1 and X2, depending on the design, machine axes Z1 and Z2 also always have to be traversed synchronously. The crossbeam 9 comprises an adjustable Y axis for traversing in the Y direction a tool holder head 10 mounted to the crossbeam 9. The traversing movements of the Z1, Z2 and Y axes are also controlled by the CNC controller 3. Said axes in each case have suitable, per se known drive means (axis drives) (not shown), which in particular each comprise a motor, one or more inverters and a transmission, for example a ball-screw drive.

To machine a workpiece (not shown), a tool holder 11 and a tool, a grinding disk 12 in the exemplary embodiment, is mounted to the tool holder head 10. The traversing movements of the tool 12 relative to the workpiece (not shown) are conventionally programmed in terms of a Cartesian machine coordinate system MCS using the visible coordinate axes +X, +Y and +Z. In the exemplary embodiment, the directions of the coordinate axes advantageously match the directions of the machine axes.

For the machine axes X1, X2, Z1 and Z2, kinematic parameters of the axes in question are stored in the CNC controller 3 in the form of maximum values (maxima) for velocity and/or acceleration and/or jerk. These maximum values are selected such that, when the axes are subject to the greatest possible admissible load, the respective axis drives are not overloaded. The CNC controller 3 determines the axis movements preferably in such a way that the stated maximum values are reached but not exceeded. Thus, however, the possibilities of the machine are often not fully utilized and the shortest possible machining time when machining a workpiece is not achieved.

The invention therefore provides for the settable maxima for the velocity and/or acceleration and/or jerk to be determined as a function of the position of the tool holder head 10 along the Y axis. The greatest maximum values may in each case then be allowed if the tool holder head 10 is located midway between the two columns 7 and 8, since then the forces caused by the weight and/or the mass (inertia) in the event of movement of the X or Z axes are transferred uniformly to the respective axes. Greater values can therefore be set compared with conventional gantry machines without overloading the respective axes.

Characteristic curves for velocity and/or acceleration and/or jerk are advantageously stored for the position-dependent maximum values in the CNC controller 3 for at least one pair of axes (X1, X2; Z1, Z2), which characteristic curves are taken into consideration by the CNC controller 3 during closed-loop control of the axes (X1, X2; Z1, Z2) in question, such that closed-loop control is carried out in each case as a function of the position of the Y axis, in order, if necessary, to achieve minimum machining times for the workpiece in question.

The CNC controller 3 automatically uses suitable software to determine the maximum admissible values for velocity and/or acceleration and/or jerk dependent on the position relative to the Y axis and the weight or the mass of the tool holder head 10, optionally with attached parts connected thereto, such as tool holder and tool. To this end, the corresponding weight or mass and the length of the Y axis may be stored in the CNC controller 3.

To achieve the shortest possible machining times, the determined, position-dependent maxima for velocity and/or acceleration and/or jerk for workpiece machining are set and preferably adapted dynamically to the current position of the tool holder head 10.

Use of the CNC controller 3 enables the weight and/or mass (inertia) of the tool holder head to be automatically determined using test runs and stored in the CNC controller 3. To this end, in the case of minimum or maximum excursion of the Y axis, runs are carried out at a constant velocity or constant acceleration. The weight or mass of the tool holder head and any attached parts mounted thereto is determined by comparing the motor currents of the parallel-traversable axes (X1, X2 or Z1, Z2). The CNC controller 3 has the necessary measuring and computing means for this purpose, and suitable software.

Unlike in the depicted gantry machine system 1, it is also possible for the two columns 7 and 8 to be fixedly mounted to the machine base 6 and for the crossbeam 9 to be adjustable solely by way of the machine axes Z1 and Z2. Adjustment in the X direction then takes place using a workpiece table (not shown) adjustable in this direction.

Furthermore, it is likewise possible for the columns 7 and 8 to be adjustable in the X direction—as shown in FIG. 1—but for the crossbeam 9 to be fixedly mounted to the two columns 7 and 8. Adjustment of the tool in the Z direction relative to the workpiece then takes place using a workpiece table (not shown) adjustable in this direction.

The latter two embodiments are also covered by the invention.

In one embodiment of the invention, the machine tool system 1 and in particular its function or mode of operation may be simulated using a digital twin of the machine tool system 1. Simulation may be carried out, for example, using the appropriately configured, external computing device 15. The digital twin in particular enables simulation of machining of a workpiece, in which the kinematic parameter is dependent on the position of the tool holder head 10 relative to the second axis Y1. In this way, for example, the time advantage achievable using the invention can be determined before a workpiece is actually machined.

It is possible, moreover, to determine the kinematic parameter, dependent on the position of the tool holder head 10, of the axes in question using the digital twin by simulating movement operations and the forces and motor currents to be expected therefrom and optionally to transfer it to the actual numerical controller.

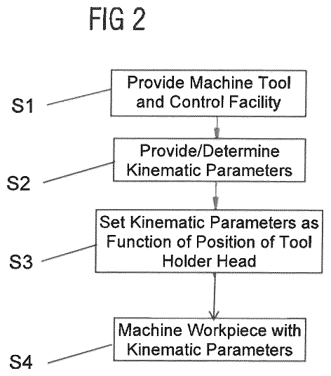

FIG. 2 shows method steps for carrying out a method according to the invention.

In a first method step S1, a machine tool 2 with a Y axis Y1, two parallel X axes X1 and X2 and/or two parallel Z axes Z1 and Z2 and a control facility 3 connected to the machine tool 2 are provided.

In a second method step, kinematic parameters in the form of admissible maximum values for velocity and/or acceleration and/or jerk are provided in the control facility or automatically determined by the control facility 3 for the axes (axis pair) X1 and X2 and/or for the axes (axis pair) Z1 and Z2, in each case as a function of the position of the Y axis.

In a third method step, the determined kinematic parameter of the first (X1, X2) and/or third (Z1, Z2) axes is set as a function of a position of the tool holder head (10) relative to the second axis (Y1).

In a fourth method step, a workpiece is machined taking account of the set kinematic parameter.

While the invention has been illustrated and described in connection with currently preferred embodiments shown and described in detail, it is not intended to be limited to the details shown since various modifications and structural changes may be made without departing in any way from the spirit and scope of the invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A machine tool system, comprising:
a machine tool comprising
a stationary machine base;
two support elements connected to the machine base and oriented in parallel in a third spatial direction;
a crossbeam connected to the two parallel support elements and oriented in a second spatial direction, the crossbeam being adjustable relative to the two parallel support elements by a third drive along two third parallel machine axes in the third spatial direction or the two support elements being adjustable relative to the machine base by a first drive along two first parallel machine axes in a first spatial direction;
a tool holder head mounted on the crossbeam and adjustable by a second drive along a second machine axis in the second spatial direction along the crossbeam; and
a control facility connected to the machine tool for controlling the second and at least one of the first drive and the third drive,
wherein at least one kinematic parameter of at least one of the first and the third machine axes is specified as a function of a position of the tool holder head relative to the second machine axis.

2. The machine tool system of claim 1, wherein the at least one specified kinematic parameter is selected from a maximum velocity, a maximum acceleration and a maximum jerk of the at least one first and third machine axis.

3. The machine tool system of claim 1, wherein the at least one specified kinematic parameter is set using a characteristic curve.

4. The machine tool system of claim 1, wherein a weight or a mass of the tool holder head is determined automatically by the machine tool system using at least one test run.

5. The machine tool system of claim 1, wherein the first and the second spatial directions are horizontally oriented and the third spatial direction is vertically oriented.

6. The machine tool system of claim 1, wherein the first, the second and the third spatial directions are oriented perpendicular to one another and form a Cartesian coordinate system.

7. The machine tool system of claim 1, wherein the machine tool is a gantry machine.

8. The machine tool system of claim 7, wherein the machine tool is a gantry milling machine or a gantry grinding machine.

9. A method for operating a machine tool system having a machine tool with a stationary machine base, two support elements oriented in parallel in a third spatial direction and connected to the machine base, a crossbeam connected to the two parallel support elements and oriented in a second spatial direction, and a tool holder head mounted on the crossbeam, the method comprising:
with a control facility connected to the machine tool adjusting the tool holder head with a second drive along a second machine axis in the second spatial direction along the crossbeam;
adjusting the crossbeam relative to the support elements with a third drive along two third parallel machine axes in the third spatial direction and/or
adjusting the two support elements relative to the machine base with the first drive along two first parallel machine axes in a first spatial direction; and
determining at least one kinematic parameter of the first and/or the third machine axes and setting the at least one kinematic parameter as a function of a position of the tool holder head relative to the second machine axis.

10. The method of claim 9, further comprising setting a maximum velocity or a maximum acceleration or a maximum jerk of the first and third machine axes as the at least one kinematic parameter.

11. The method of claim 9, further comprising setting a dependency of the at least one kinematic parameter using a characteristic curve.

12. The method of claim 9, further comprising determining a weight or a mass of the tool holder head automatically using at least one test run.

13. A control facility for controlling the machine tool system of claim 1.

14. The control facility of claim 13, embodied as a numerical controller.

15. The control facility of claim 13, wherein the control facility is configured to acquire a weight or a mass of the tool holder head and to set the at least one kinematic parameter automatically as a function of a position of the tool holder head relative to the second machine axis and of the acquired weight or the acquired mass of the tool holder head.

16. A digital twin of the machine tool system of claim 1, wherein the digital twin is configured to simulate machining of a workpiece with the at least one kinematic parameter being dependent on a position of the tool holder head relative to the second machine axis.
